(19) United States
(12) Patent Application Publication
(10) Pub. No.: US 2011/0181514 A1
(43) Pub. Date: Jul. 28, 2011

(54) Touch keypad for touch screen devices

(76) Inventor: Hassan Aboulhosn, Fairfax, VA (US)

(21) Appl. No.: 12/928,457

(22) Filed: Dec. 10, 2010

Related U.S. Application Data
(60) Provisional application No. 61/282,085, filed on Dec. 14, 2009.

(51) Int. Cl. G06F 3/02

(52) U.S. Cl. 345/169

(57) ABSTRACT

A touch keypad is provided for touch screen devices, the touch keypad having a thin flexible body which is substantially transparent and which provides a keyboard feel, and which can overlie a display portion of a touchscreen device. The touch keypad a nonwoven or woven plastic material which is thin and provides raised portions to provide a tactile feel, the raised portions corresponding to specific keys of a touchscreen display. Alternatively, the device may instead include a flexible thin material, including thin woven or non-woven material, other than plastic. Such thin materials could include a thin glass material, extremely thin transparent steel with stamped or molded raised or depressed portions, or can include a paper material which is thin and provides raised portions to provide a tactile feel, the raised portions corresponding to specific keys of a touchscreen display.

### CLAIM FOR PRIORITY AND CROSS-REFERENCE TO RELATED APPLICATIONS

This application claims the priority of Provisional Patent Application Ser. No. 61/282,085, filed on Dec. 14, 2009.

### STATEMENT REGARDING FEDERALLY SPONSORED RESEARCH OR DEVELOPMENT

Not applicable.

### FIELD OF THE INVENTION

The present invention relates generally to a touch keypad for touch screen devices such as handheld cell phones, music players, video players, and gaming devices.

### BACKGROUND OF THE INVENTION

Touch keypads are known for computer keyboards and for other electronic devices requiring a keyed input. Such devices use electrical connections to detect the keystrokes and to input information about the selected key to the computer or other electronic device. Such known touch keypads are complex and require both mechanical and electrical parts.

Touch screen input devices are known for use with computer screens and electronic handheld portable devices including handheld cell phones, music players, video players, and the like. In these devices, a display screen includes a keypad display and has sensors to detect a touch, and electronic circuitry or programs are used to associate that touched portion with a key selection. For example, a standard QWERTY keyboard may be shown on the touch screen device, and a touch over the letter Q, for example, will cause the device to recognize that a Q has been intended as the input.

However, such touchscreen devices are awkward and clumsy to use, since the touch is flat. Because there is no tactile keyboard, it is frequently necessary to visually inspect the display to make sure the correct keys are actuated.

This problem persists even with modern cell phone texting keyboards, even those which have a click or vibration to indicate a key has been activated, since the user must still look at the display while typing. Even a skilled touch typist will have trouble using such touchscreens, however, since the displayed keypads are typically small and it is difficult to precisely strike a given key. In this case, even a slight mis-strike results in an erroneous keyboard entry.

It is accordingly a problem in the prior art to provide a device rendering touchscreen keypads more useful and easier to use, with greater accuracy, and permitting touch typing by providing tactile keyboard feel. It is a further problem to provide such a device that is inexpensive, light, non-bulky, and even disposable.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides a touch keypad for touch screen devices having a thin flexible body which is substantially transparent and which provides a keyboard feel, and which can overlie a display portion of a touchscreen device.

The device according to the present invention includes a nonwoven or woven plastic material which is thin and provides raised portions to provide a tactile feel, the raised portions corresponding to specific keys of a touchscreen display.

Alternatively, the device may instead include a flexible thin material, including thin woven or non-woven material, other than plastic. Such thin materials could include a thin glass material with molded raised or depressed portions corresponding to keys; extremely thin transparent steel with stamped or molded raised or depressed portions corresponding to specific keys of a touchscreen display; and even can include a paper material which is thin and provides raised portions to provide a tactile feel, the raised portions corresponding to specific keys of a touchscreen display.

Other objects and advantages of the present invention will be more readily apparent from the following detailed description when read in conjunction with the accompanying drawings.

### BRIEF DESCRIPTION OF THE DRAWINGS

FIG. 1 is a schematic, perspective view of a touch keypad and an associated touch screen device, according to the present invention.

FIG. 2 is a schematic elevational view of a touch keypad for use with the touch screen device of FIG. 1.

FIG. 3 is a schematic elevational view of a touch keypad as shown in FIG. 2, showing specific raised portions intended to overlie displayed keyboard elements in the touchscreen display of FIG. 1.

FIG. 4 is a side view of the touch keypad of FIG. 3 taken along line 4-4 of FIG. 3.

FIG. 5 is a top elevational view of details of a key touch portion of a the keypad of FIG. 2.

FIG. 6 is a side schematic view showing the touch keypad of FIG. 2 of the present invention in relation to a touch display of an electronic touchscreen device.

FIG. 7 is a perspective view of an alternative touch keypad with the raised portions on the underside, in facing engagement with the electronic display.

FIG. 8 is another perspective view of a raised element of the keypad according to the present invention, having round features.

FIG. 9 is schematic perspective view of another embodiment of the touch keypad according to the present invention, in which the touch keypad is formed as an endless belt.

FIG. 10 is another schematic alternative embodiment of the touch keypad according to the present invention, in which the touch keypad is formed as a hinged member inside a casing for the electronic device, so that the touch keypad can be manually overlaid on, and manually removed from, the electronic display.

FIG. 11 is a schematic side sectional view of the keypad of FIG. 2 in which the elements are formed as solid raised portions.

FIG. 12 shows the touch keypad of FIGS. 1-4 of the present invention, actuated by a finger of a user.

FIG. 13 shows another alternative keypad having attachment arms for securement to a cell phone.

FIG. 14 shows a bottom view of the keypad of FIG. 13, showing attachment to a cell phone shown in phantom outline.

FIG. 15 shows a further alternative embodiment of a keypad similar to that shown in FIG. 1, and having conductive elements attached to each keypad electrically connected to a capacitor to improve performance in operation with capacitive electronic surfaces such as touch screen cell phones.

FIG. 16 is a schematic side view of a single keypad of FIG. 15 having a metallic element electrically connected to the capacitor of FIG. 15.

### DETAILED DESCRIPTION OF THE INVENTION

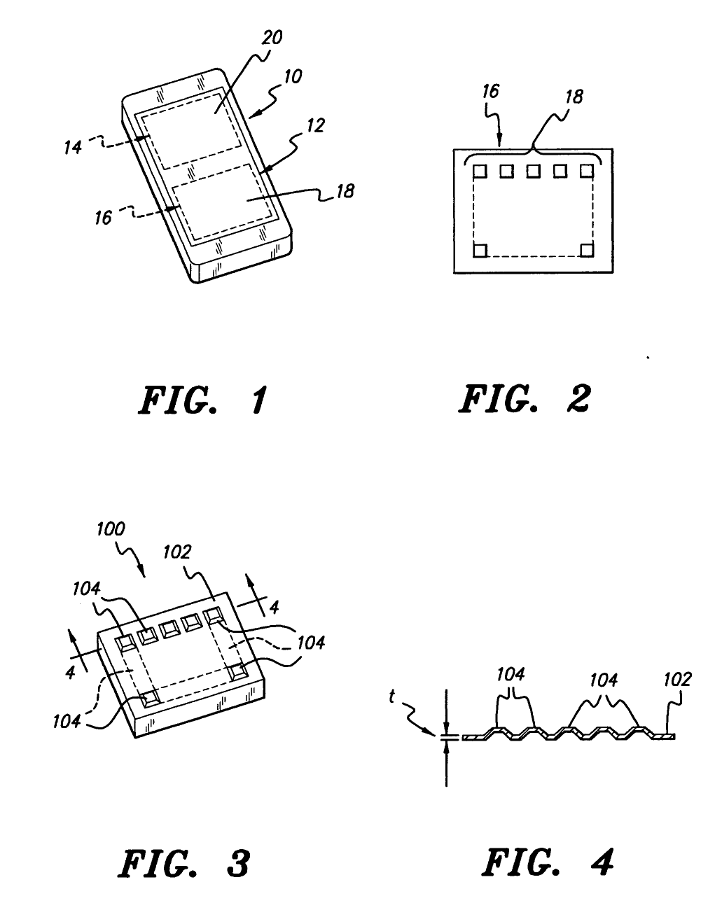

FIG. 1 is a schematic, perspective view of a touch keypad 12 and an associated touch screen device 10. The device 10 has a flat touchscreen with a visible keypad area in an area under a touch keypad portion 16 indicated by dashed outline. Another area 20 indicated in dashed outline 14 is either occupied by other program indicia or is clear. An area 18 is a portion of the touch keypad 12 occupied by touch elements, which are shown in further detail in FIGS. 3 and 4.

While the orientation of the keypad in FIG. 1 is vertical relative to the device 10, some electronic cell phone devices have a gravity switch and can change the orientation of the displayed keyboard keys, and in that case the keypad would be oriented in a vertical direction relative to the device 10 of FIG. 1, and could occupy a larger portion of the visible screen.

FIG. 2 is a schematic elevational view of the touch keypad portion 16 having a plurality of keypad elements 18 for use with the touch screen device 10 of FIG. 1.

FIG. 3 is a schematic elevational view of a touch keypad 100 of the type shown in FIG. 2, showing a relatively flat body portion 102 together with raised portions 104 intended to overlie displayed keyboard elements in the touchscreen display device 10 of FIG. 1.

FIG. 4 is a side view of the touch keypad 100 of FIG. 3 taken along line 4-4 of FIG. 3. Here, the body portion 102 and raised portions 104 of the touch keypad 100 have a thickness t which is relatively thin so as to be readily deformable when touched by a user. The user can feel the raised portions 104, even as those raised portions 104 deform into contact with the touch screen display of the device 10.

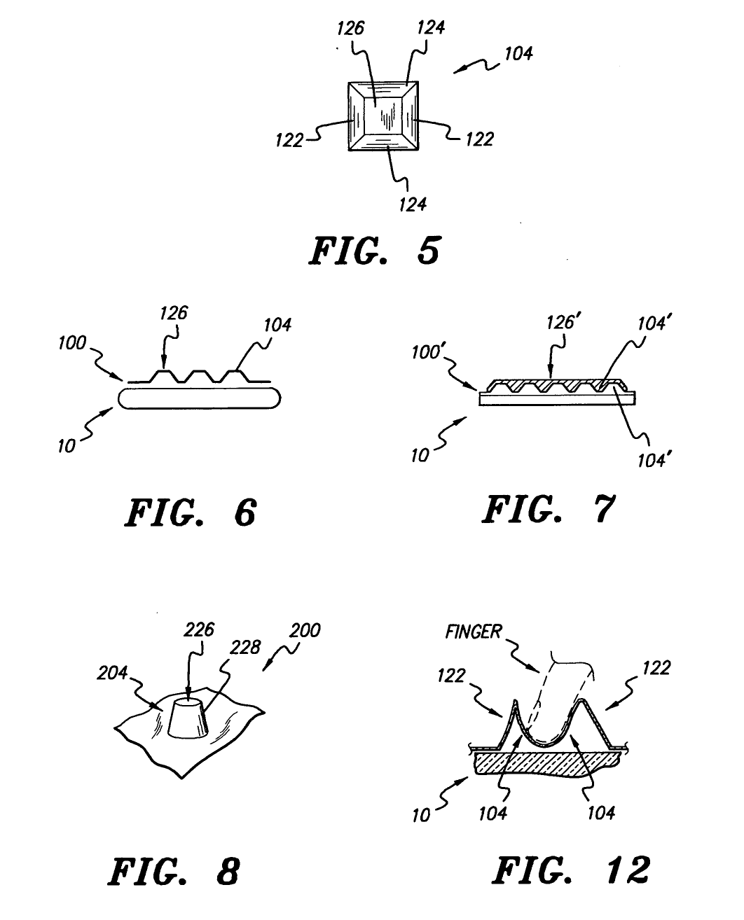

FIG. 5 is a top elevational view of details of a key touch portion of the keypad of FIG. 2. Here, the raised portions 104 are formed by a flat peak 126 bounded by upper and lower sidewalls 124, 124 and by left and right sidewalls 122, 122.

FIG. 6 is a side schematic view showing the touch keypad 100 of FIG. 2 in overlying relation to a touch display of an electronic touchscreen device 10.

FIG. 7 is a perspective view of an alternative touch keypad 100′ having a body with the peaks 126′ being level with the upper surface of the touch keypad 100′ but with underlying solid portions 104′ which directly overlie the displayed keypad elements of the electronic display device 10, where the solid portions 104′ are in contact with the touch screen of the electronic display 10.

FIG. 8 is a perspective view of another embodiment of a touch keypad 200, having a plurality of raised elements 204, each element 204 having a peak 226 and conical sidewall 228. Other shapes are contemplated as being within the scope of the present invention.

FIG. 9 is schematic perspective view of another embodiment of the touch keypad 300, in which the touch keypad is formed as an endless belt having a band-shaped body portion 316 and raised elements 104. The electronic device 10 is shown schematically in dashed outline in FIG. 9. In this embodiment, the body portion 316 can carry more than one region of keypad elements 104, one being for a horizontal keypad display and another region for a vertical keypad display. Other keypad displays can be arranged as well, for example a numeric keyboard arrangement for a calculator can be provided.

FIG. 10 is another schematic alternative embodiment of the touch keypad, in which the touch keypad 104 is formed as a sheet supported by a flexible hinged member 502 which is part of a casing 500 for the electronic device, the casing 500 having a hinged cover 504. This arrangement enables the touch keypad 104 to be manually overlaid on, and manually removed from, the electronic display 10.

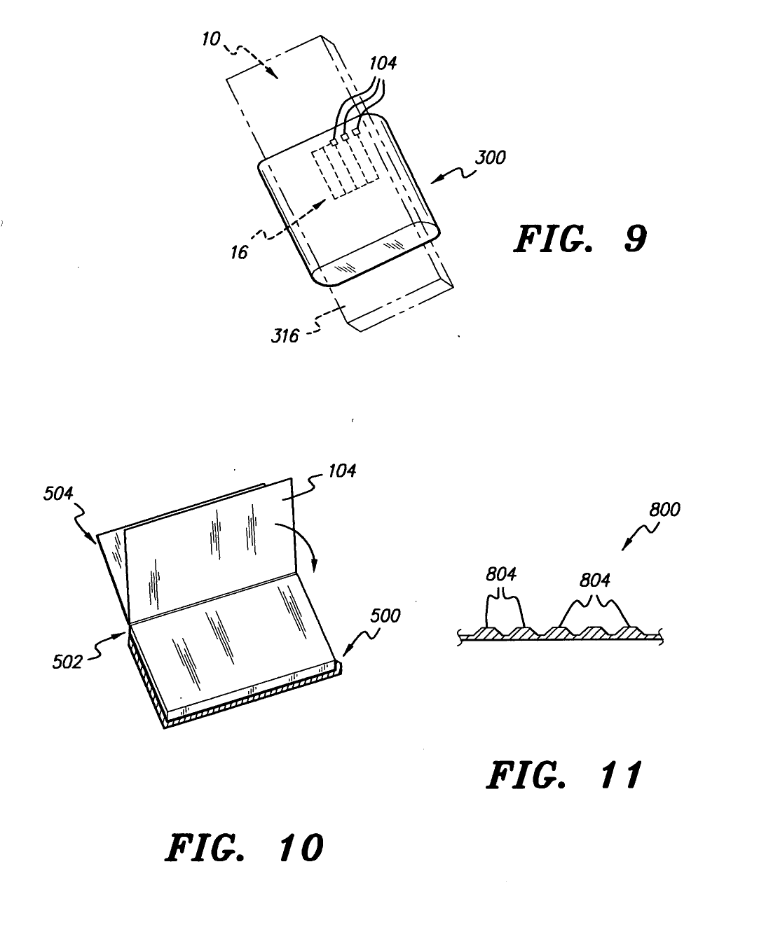

FIG. 11 is a schematic side sectional view of another alternative embodiment of the keypad of FIG. 2, in which a keypad 800 has raised elements 804. The elements 804 correspond to the elements 104 of FIGS. 1-4, though in which the elements 804 are formed as solid raised portions.

FIG. 12 shows the touch keypad 10 of FIGS. 1-4 of the present invention, actuated by a finger of a user. The element 104 is deformed at its center into touching contact with the underlying touchscreen display of the electronic device 10.

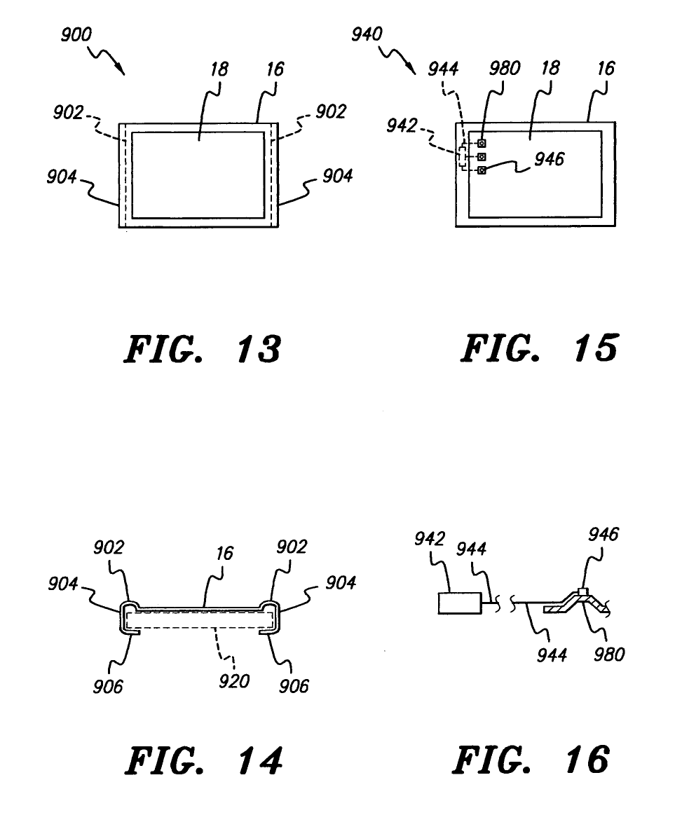

FIG. 13 shows another alternative keypad 18 similar to that of FIG. 1, and having attachment arms 902, 902 for securement to a cell phone (shown in FIG. 14 in phantom outline). The arms 902, 902 have central arm portions 904, 904 each having a securing arm portion 906, 906 respectively, and each of the arm portions 902, 902 being respectively connected at one end to the keypad 18. The arms 902, 902 can thereby resiliently secure the cell phone 920 of FIG. 14 therebetween, and can be resiliently deformed when being removed from the cell phone 920.

FIG. 14 shows a bottom view of the keypad 18 of FIG. 13, showing attachment to a cell phone 920 shown in phantom outline. The arms 902, 902 are as discussed hereinabove with reference to FIG. 13.

FIG. 15 shows a further alternative embodiment of a keypad 18 similar to that shown in FIG. 1, and having conductive elements 980 attached to each keypad which are electrically connected by wires 944 to a capacitor 942 to improve performance of the keypad 18 when in operation with capacitive electronic surfaces such as those in touch screen cell phones and touch screen computer pads or other capacitive surface devices.

FIG. 16 is a schematic side view of a single keypad element 980 of FIG. 15 having a metallic element 946 thereon which is electrically connected by the wire 944 to the capacitor 942. The capacitor can be replaced by more complex circuitry having capacitors and other elements, as in U.S. Pat. Nos. 4,922,061 and 7,436,164. While the metallic element 946 is shown atop the element 980, it could instead be embedded therein, or disposed on the underside thereof. Alternatively the electrical path can be formed of a conductive plastic material built into the keypad 18 and the keypad element 980.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A touch keypad is provided for touch screen devices, comprising:
a thin flexible body which is substantially transparent; and
a plurality of raised keyboard elements which provides a keyboard feel, and which can overlie a display portion of a touchscreen device,
whereby a user typing on the keyboard elements can feel the raised keyboard elements while typing, improving typing accuracy and speed.

2. A touch keypad according to claim 1, in which the thin flexible body is composed of a nonwoven plastic material.

3. A touch keypad according to claim 1, in which the thin flexible body is composed of a woven plastic material.

4. A touch keypad according to claim 1, in which the thin flexible body is composed of one of a thin glass material.

5. A touch keypad according to claim 1, in which the thin flexible body is composed of a very thin transparent steel with stamped or molded raised or depressed portions.

6. A touch keypad according to claim 1, in which the thin flexible body is composed of a paper material which is thin and provides raised portions to provide a tactile feel, the raised portions corresponding to specific keys of a touchscreen display.

7. A touch keypad is provided for capacitive touch screen devices, comprising:
a thin flexible body which is substantially transparent;
a capacitor connected to said thin flexible body; and
a plurality of raised keyboard elements which provides a keyboard feel, and which can overlie a display portion of a touchscreen device, each of said plurality of keyboard elements having a metallic element electrically connected to the capacitor so as to enable capacitive interaction with a capacitive touch screen device when disposed in contact with the capacitive touch screen device;
whereby a user typing on the keyboard elements can feel the raised keyboard elements while typing, improving typing accuracy and speed.
